(19) United States
(12) Patent Application Publication
(10) Pub. No.: US 2022/0393415 A1
(43) Pub. Date: Dec. 8, 2022

(54) PANEL MOUNTED CHARGING SYSTEMS WITH INTERCHANGEABLE MODULES

(71) Applicants: Charles Schneider, Denver, CO (US); Brian Domarek, Denver, CO (US); Dominic Martinez, Aurora, CO (US)

(72) Inventors: Charles Schneider, Denver, CO (US); Brian Domarek, Denver, CO (US); Dominic Martinez, Aurora, CO (US)

(21) Appl. No.: 17/340,391

(22) Filed: Jun. 7, 2021

(51) Int. Cl. H01R 31/06; H02J 7/00; H01R 13/73

(52) U.S. Cl. CPC H01R 31/065; H02J 7/0042; H01R 13/73

(57) ABSTRACT

Charging systems configured to charge a device with a power connector configured to operate at specified power parameters. The charging systems include a base module and a removable module. The base module fixedly mounts to a panel and electrically couples to a power supply. The removable module removably and electrically couples to the base module. The removable module includes an electronics system and a power receptacle. The electronics system converts a supply current from the removable module to an output current matching the specified power parameters of the power connector. The power receptacle is complementarily configured with the power connector to electrically couple with the power connector. In some examples, the base module is configured to mount to the panel in a range of orientations to facilitate electrically coupling with the power supply and to receive the removable module in an upright orientation regardless of the base module's orientation.

### BACKGROUND

The present disclosure relates generally to charging systems. In particular, panel mounted charging systems with interchangeable modules are described.

Electronic devices require power to operate. One important, reliable means for electronic devices to receive power from a power source is through physical connectors. Universal Serial Bus (USB) connectors are one type of power connector for electronic devices and there are many other types as well. This discussion will focus on USB connectors for simplicity, but the reader should understand that the topics and inventions described herein are applicable to a wide range of power connectors beyond USB connectors.

In more detail, USB is an industry standard that establishes specifications for cables and connectors. USB also establishes standard protocols for devices to connect, communicate, and transfer power. A broad variety of USB hardware exists, including eleven different connectors, of which USB-C is the most recent.

Released in 1996, the USB standard is maintained by the USB Implementers Forum (USB-IF). There have been four generations of USB specifications: USB 1.x, USB 2.0, USB 3.x, and USB 4.x.

Separate from the standard, but linked, are the connectors and receptacles used on the cables. The USB connectors and receptacles have evolved from 1996 (USB 1.0) to 2019 (USB 4.0). The connectors have included Type A connectors for USB 1.0, 1.1, and 2.0. protocols with 4 or 5 wires; Type A connector for USB 3.0 and 3.1 protocols with 9 wires; Type B connectors for USB 1.0, 1.1, and 2.0 protocols with 4 wires; Type B connectors for USB 3.0, and 3.1 protocols with 9 wires; and Type C connectors for USB 2.0, 3.0, 3.1, 3.2, and 4.0 protocols with up to 24 wires. There are also Mini and Micro USB connectors.

Companies make USB charging devices to power and/or recharge batteries of devices with USB connectors. USB charging devices receive a current at an input voltage and wattage from a power source and convert it to the power requirement of a given USB standard and connector.

As described above, the power requirements of a USB standards and connectors change as the protocols and connectors evolve over time. Each time the USB standard changes (either the protocol or the connector), manufactures of USB chargers must develop new chargers that are equipped to handle the number of wires, the type of connector and, at times, the USB protocol for power delivery matching to the capability of the device.

One popular type of USB charger is a panel mounted USB charger. A common setting where panel mounted USB chargers are used is a cockpit of an airplane. The panel mounted USB charger mounted to the instrument panel in the cockpit gives pilots ready access to connect USB devices to power and/or recharge them. For example, a pilot may connect a USB connector for a tablet computer to a USB panel mounted charger to power the tablet computer. The pilot may then use the tablet computer to access maps and flight data.

Manufacturers of panel mounted USB chargers have heretofore designed their chargers as a single, self-contained unit. Typically, a hole is cut in the panel and the box containing the USB Chargers is installed from behind the panel and secured into place. Every time the USB protocols and/or connectors have evolved (USB 2.0/Type A connector to USB 3.0/Type B connector for example), the entire existing charger must be replaced to accommodate the new USB standard.

Replacing a conventional panel mounted USB charger is labor intensive and expensive. The entire panel must be taken apart, the existing, now obsolete. USB charger must be removed, and a new USB charger installed in its place. Over the course of time, the labor expenses become more significant. For example, one would have incurred labor costs at least four times to keep USB panel mounted chargers current over the past 10 years as USB standards evolved.

The USB standards will continue to evolve and require that existing USB charging devices mounted to instrument panels be replaced often over time to enable new devices to use them. Under current practices, entirely new USB charging devices will have to be reinstalled to panels each time. Installing new USB charging devices involves the attendant costs of the new USB charging device, the labor to disassemble, install, and reassemble the panel, and the down time for the vehicle.

It would be desirable to reduce the expense necessary to modify panel mounted USB charging devices to keep them current with evolving USB standards. It would further be desirable to enable panel mounted USB charging devices to be modified to work with new USB standards quickly and easily.

Thus, there exists a need for charging systems that improve upon and advance the design of known charging systems. Examples of new and useful charging systems relevant to the needs existing in the field are discussed below.

### SUMMARY

The present disclosure is directed to charging systems configured to charge a device with a power connector configured to operate at specified power parameters. The charging systems include a base module and a removable module. The base module fixedly mounts to a panel and electrically couples to a power supply. The removable module removably and electrically couples to the base module. The base module delivers a supply current from the power supply to the removable module. The removable module includes an electronics system and a power receptacle. The electronics system converts the supply current to an output current matching the specified power parameters of the power connector. The power receptacle is complementarily configured with the power connector to electrically couple with the power connector and to deliver the output current to the power connector.

In some examples, the base module is configured to mount to the panel in a range of orientations to facilitate electrically coupling with the power supply and to receive the removable module in an upright orientation regardless of the base module's orientation.

### BRIEF DESCRIPTION OF THE DRAWINGS

FIG. 1 is a schematic view of a charging system depicting two removable modules that can interchangeably couple to a base module mounted to a panel.

FIG. 2 is a top, front perspective view of a first embodiment of a charging system.

FIG. 3 is a top, rear perspective view of the charging system shown in FIG. 2.

FIG. 4 is a perspective view of the charging system shown in FIG. 2 with a removable module separated from a base module.

FIG. 5 is an exploded view of the charging system shown in FIG. 2.

FIG. 6 is a front elevation view of the charging system shown in FIG. 2 depicting a display.

FIG. 7 is a side elevation view of the charging system shown in FIG. 2 depicting a button a user may press to control the brightness of the display or to turn the display on or off.

FIG. 8 is a top elevation view of the charging system shown in FIG. 2.

FIG. 9 is a side elevation view of the charging system shown in FIG. 2 depicting a button a user may press to control charging.

FIG. 10 is a perspective view of a second embodiment of a charging system, the charging system including a removable module and a base module that threadingly couple.

### DETAILED DESCRIPTION

The disclosed charging systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various charging systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Panel Mounted Charging Systems with Interchangeable Modules

With reference to the figures, panel mounted charging systems with interchangeable modules will now be described. The charging systems discussed herein function to power devices with specific connectors. In some examples, the charging systems power devices with USB connectors. Of particular note, the charging systems described in this document function to interchange modules to enable connecting with different types of power connectors and/or to enable supplying power at different power parameters as needed by a given connecter protocol.

The reader will appreciate from the figures and description below that the presently disclosed charging systems address many of the shortcomings of conventional charging systems. For example, the charging systems described herein significantly reduce the expense necessary to modify panel mounted charging devices to keep them current with evolving power connector standards, such as USB connector standards. The charging systems described in this document allow panel mounted charging devices to be modified to work with new power connection standards quickly and easily.

Contextual Derails

Ancillary features relevant to the charging systems described herein will first be described to provide context and to aid the discussion of the charging systems.

Panel

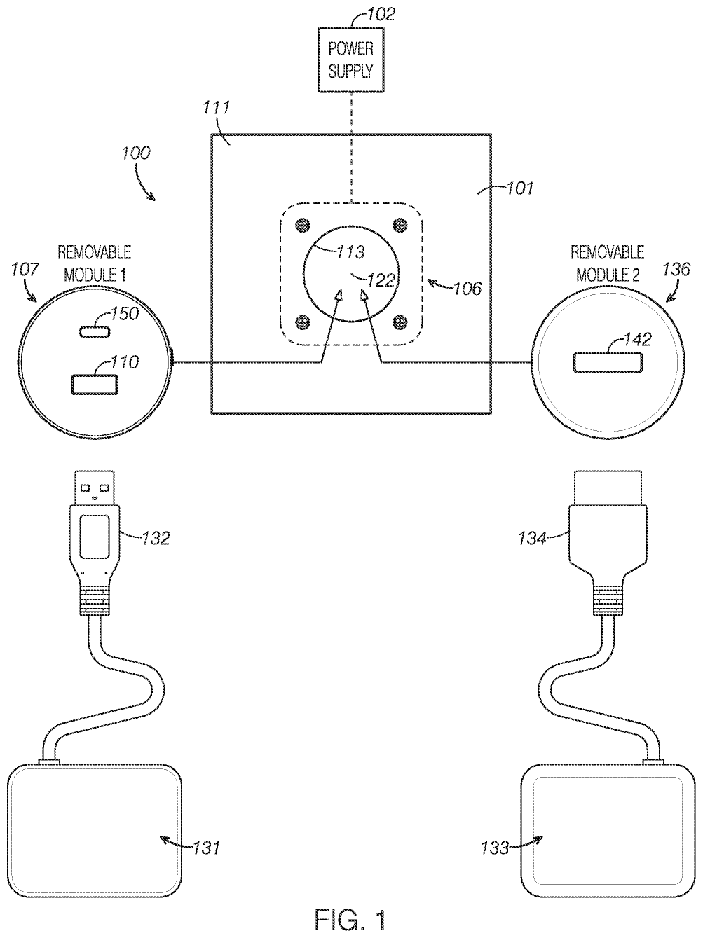

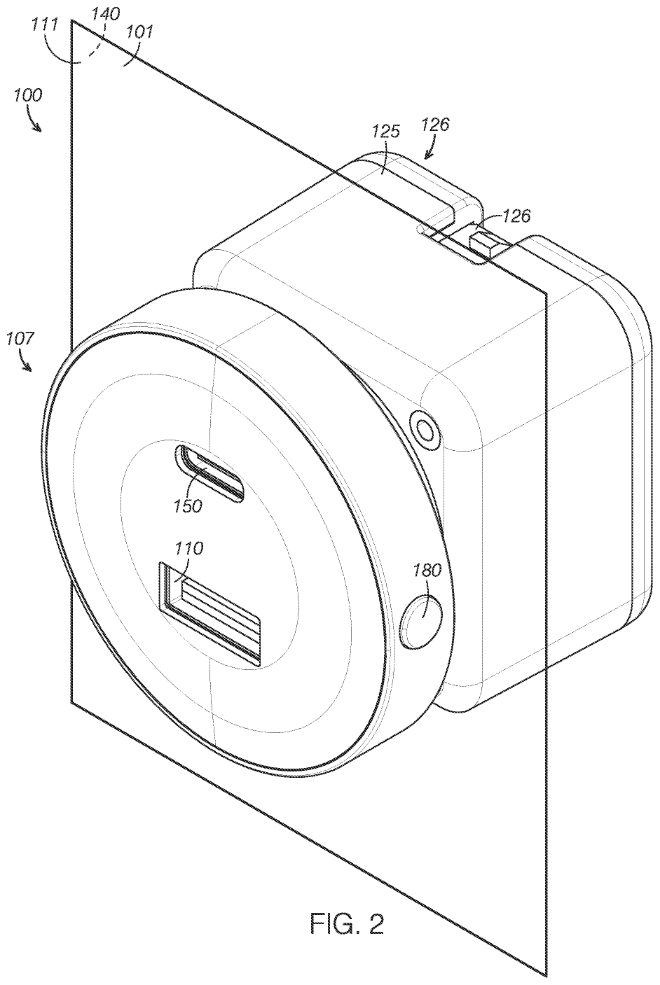

The charging systems described below are configured to mount to panels, such as instrument panels, arm rest panels, seat back panels, and many other types of panels. FIGS. 1 and 2 depict a panel 101 as representative of the many types of panels to which charging system 100 may mount.

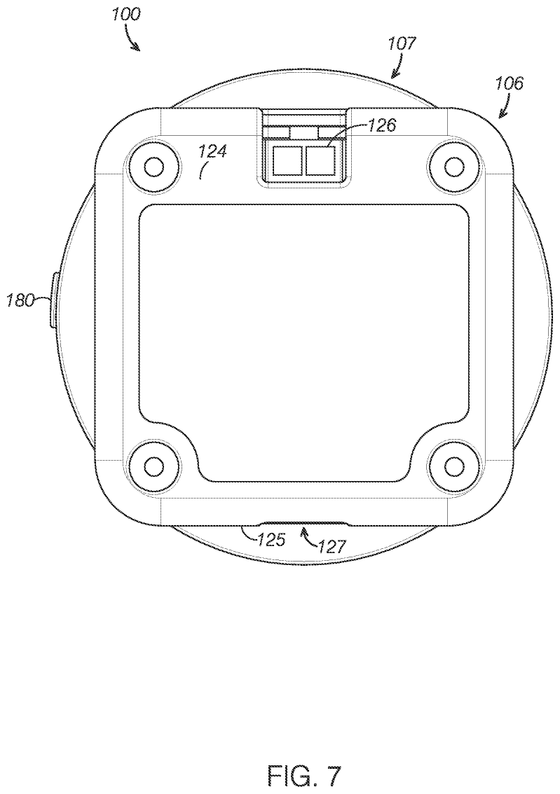

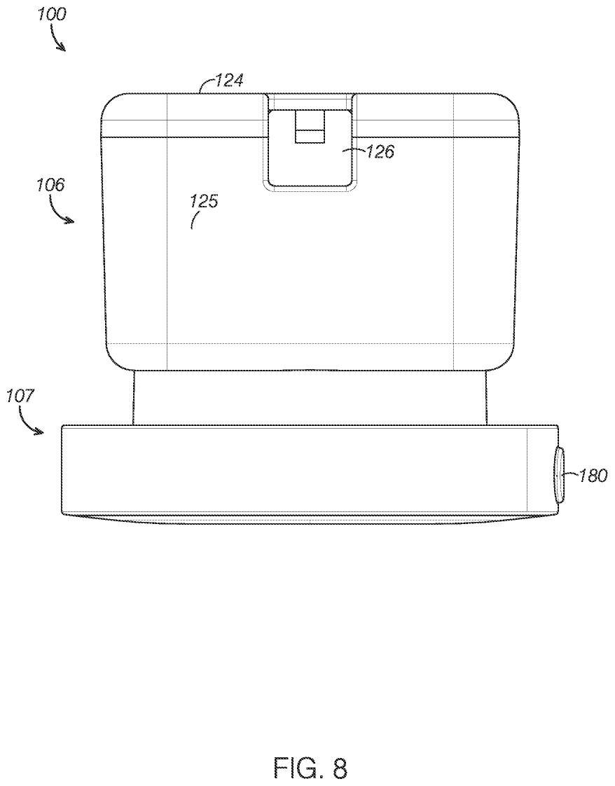

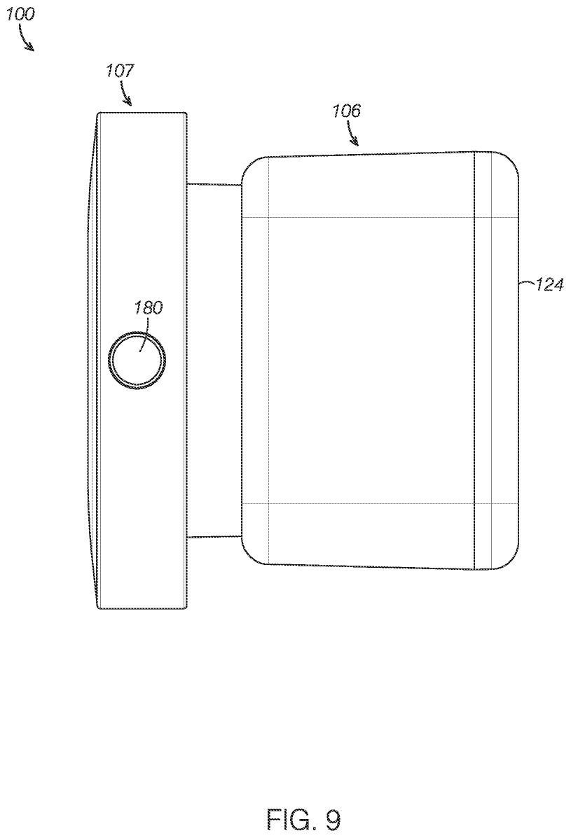

In the example shown in FIGS. 1-9, charging system 100 is configured to mount to panel 101 with four screws. However, the charging system may mount to the panel by any currently known or later developed means, such as adhesives, hook-and-loop fasteners, magnetic couplers, and other types of mechanical fasteners beyond screws.

As depicted in FIG. 1, panel 101 has access to a power supply 102. With reference to FIGS. 1 and 2, panel 101 has an external side 111 facing a user and internal side 140 opposite external side 111 facing away from the user.

The size of the panel may be varied as needed for a given application. In some examples, the panel is larger relative to the other components than depicted in the figures. In other examples, the panel is smaller relative to the other components than depicted in the figures. Further, the reader should understand that the panel and the other components may all be larger or smaller than described herein while maintaining their relative proportions.

The panel may be any currently known or later developed type of panel. The reader will appreciate that a variety of panel types exist and could be used in place of the panel shown in the figures. In addition to the types of panels existing currently, it is contemplated that the charging systems described herein could be used with new types of panels developed in the future.

Power Supply

The charging systems described in this document receive power from a power supply. FIG. 1 depicts a power supply 102 supplying charging system 100 with a supply current. The supply current has certain supply power parameters, namely, a given voltage and amperage of the supply current. The supply power parameters may not be suitable for a given device and/or physical connector power protocols without modification.

Devices

The charging systems described below function to supply power to various devices. In particular, the charging systems supply power to devices with compatible power connectors and compatible power protocols or parameters. FIG. 1 depicts two devices, first device 131 and second device 133, that may receive power from charging system 100.

The devices may be any currently known or later developed type of electronic device, such as mobile phones, computers, and the like. The reader will appreciate that a variety of device types exist and could be used in place of the devices shown in the figures. In addition to the types of devices existing currently, it is contemplated that the charging systems described herein could be used to supply power to new types of devices developed in the future.

As shown in FIG. 1, first device 131 has a first power connector 132 and second device 133 has a second power connector 134. In the example shown in FIG. 1, first power connector 132 and second power connector 134 are both USB connectors, but the reader should understand that the power connectors could be any currently known or later developed type of power connector.

The reader can see that first power connector 132 and second power connector 134 are different. In the present example, first power connector 132 is smaller than second power connector 134, but they could be the same size or the first power connector could be larger than the second power connector. In some examples, the power connectors are the same size but the devices to which they are coupled require different power parameters, such as different voltages or different amperages. In the example shown in FIG. 1, first device 131 is configured to require power at first specified power parameters and second device 133 is configured to require power at second specified power parameters that are different than the first specified power parameters.

The power connectors may be any currently known or later developed type of power connector. The reader will appreciate that a variety of power connector types exist and could be used in place of the power connectors shown in the figures. In addition to the types of power connectors existing currently, it is contemplated that the charging systems described herein could incorporate new types of power connectors developed in the future.

The shape of the power connectors may be adapted to be different than the specific examples shown in the figures to suit a given application. For example, one or more of the power connectors may include a face having the shape of a regular or irregular polygon, such as a circle, oval, triangle, square, rectangle pentagon, and the like. Additionally or alternatively, one or more of the power connectors may include a face having an irregular shape. In three dimensions, the shape of the power connectors may be a sphere, a pyramid, a cone, a cube, and variations thereof, such as a hemisphere or a frustoconical shape.

The size of the power connectors may be varied as needed for a given application. In some examples, the power connectors are larger relative to the other components than depicted in the figures. In other examples, the power connectors are smaller relative to the other components than depicted in the figures. Further, the reader should understand that the power connectors and the other components may all be larger or smaller than described herein while maintaining their relative proportions.

The specified power parameters may be any currently known or later developed type of power parameters. The reader will appreciate that a variety of power parameters exist for different devices and could be used in place of the specified power parameters discussed in this document. In addition to the power parameters existing currently, it is contemplated that the charging systems described herein could be used with devices requiring new power parameters specified or developed in the future.

### Charging System Embodiment One

With reference to FIGS. 1-9, a charging system 100 will now be described as a first example of a charging system. The reader can see in FIGS. 1-9 that charging system 100 is configured to charge a first device 131 or a second device 133. As depicted in FIGS. 1-5 and 7-9, charging system 100 includes a base module 106 and a removable module 107. In other examples, the charging system includes fewer components than depicted in the figures. In certain examples, the charging system includes additional or alternative components than depicted in the figures.

Base Module

Base module 106 functions to mount to panel 101 and to selectively couple with removable module 107. Base module 106 also functions to transfer power from power supply 102 to removable module 107. In the example shown in FIG. 1, base module 106 delivers a supply current from power supply 102 to removable module 107.

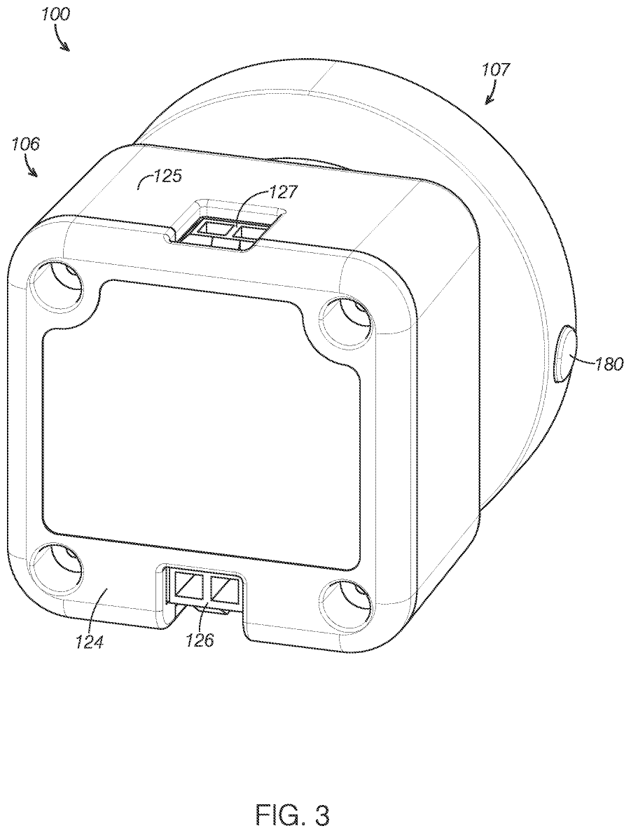

With reference to FIGS. 1 and 2, base module 106 fixedly mounts to panel 101 with screws and electrically couples to power supply 102. The reader can see in FIGS. 1 and 2 that base module 106 is mounted to internal side 140 of panel 101. As depicted in FIG. 3, base module 106 includes two source connectors, a first source connector 126 and a second source connector 127, to electrically couple to power supply 102.

As shown in FIG. 3, base module 106 includes multiple faces, including a rear face 124 and a lateral face 125. With reference to FIG. 3, the reader can see that lateral face 125 is disposed transverse to rear face 124. The reader can see in FIGS. 2 and 3 that base module 106 is configured to mount to panel 101 with lateral face 125 oriented in a desired direction within a 360-degree range to more conveniently couple to power supply 102.

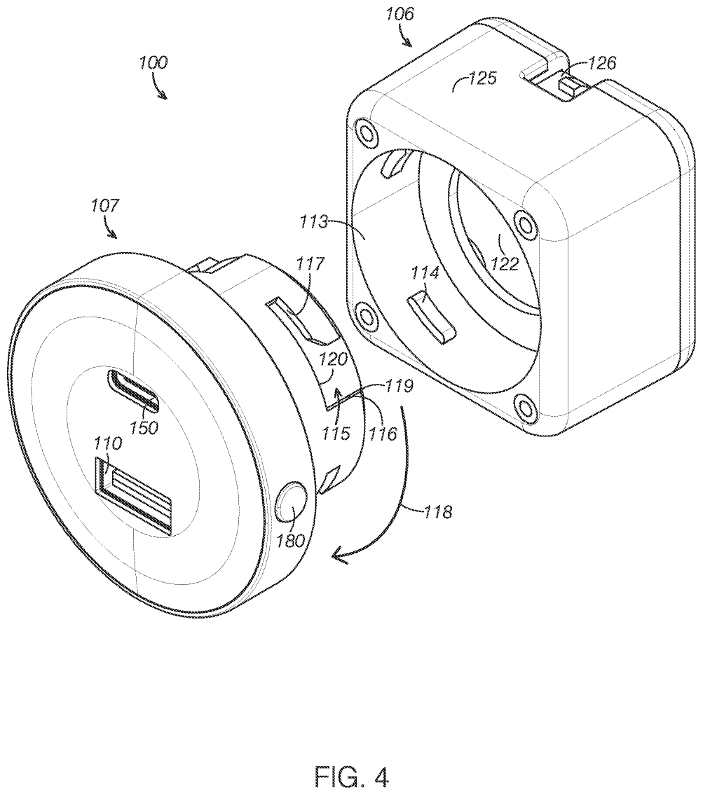

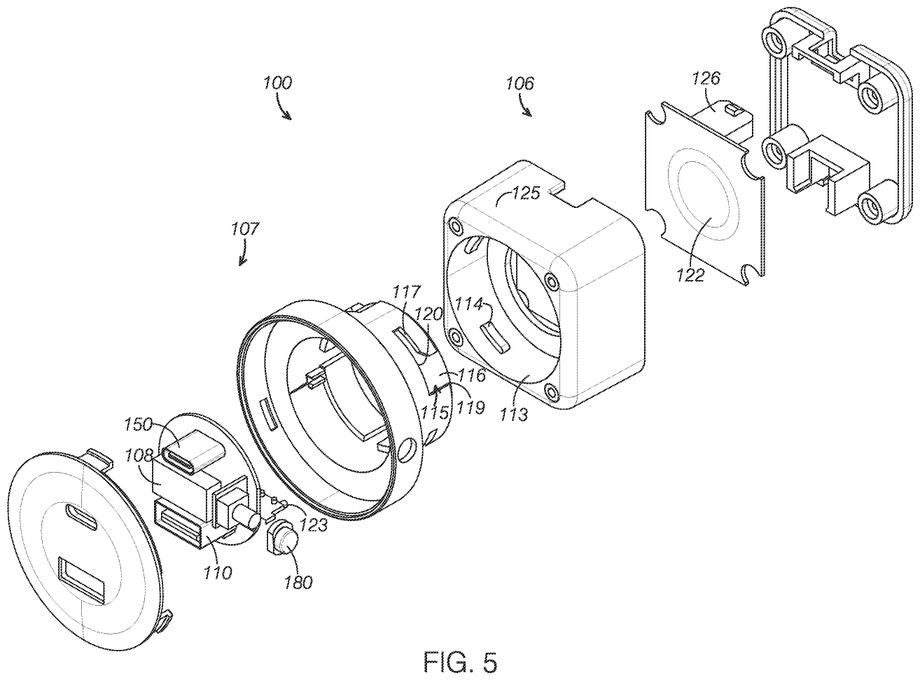

As depicted in FIGS. 1, 4, and 5, base module 106 defines a coupling receptacle 113. As shown in FIGS. 4 and 5, base module 106 includes a back plate 122 disposed on coupling receptacle 113 distal panel 101. Further, with continued reference to FIGS. 4 and 5, base module 106 includes a tab 114 disposed in coupling receptacle 113.

The size of the base module may be varied as needed for a given application. In some examples, the base module is larger relative to the other components than depicted in the figures. In other examples, the base module is smaller relative to the other components than depicted in the figures. Further, the reader should understand that the base module and the other components may all be larger or smaller than described herein while maintaining their relative proportions.

The shape of the base module may be adapted to be different than the specific examples shown in the figures to suit a given application. For example, the base module may include a face having the shape of a regular or irregular polygon, such as a circle, oval, triangle, square, rectangle pentagon, and the like. Additionally or alternatively, the base module may include a face having an irregular shape. In three dimensions, the shape of the base module may be a sphere, a pyramid, a cone, a cube, and variations thereof, such as a hemisphere or a frustoconical shape.

Coupling Receptacle

The role of coupling receptacle 113 is to receive removable module 107. As depicted in FIGS. 1, 4, and 5, coupling receptacle 113 is complementarily configured with removable module 107 to receive removable module 107. In particular, coupling receptacle 113 receives removable module 107 in a position where contact member 123 of removable module 107 contacts back plate 122 to electrically couple contact member 123 with back plate 122. Electrically coupling contact member 123 with back plate 122 electrically couples removable module 107 with power supply 102.

The shape of the coupling receptacle may be adapted to be different than the specific examples shown in the figures to suit a given application. For example, the coupling receptacle may include a face having the shape of a regular or irregular polygon, such as a circle, oval, triangle, square, rectangle pentagon, and the like. Additionally or alternatively, the coupling receptacle may include a face having an irregular shape. In three dimensions, the shape of the coupling receptacle may be a sphere, a pyramid, a cone, a cube, and variations thereof, such as a hemisphere or a frustoconical shape.

The size of the coupling receptacle may be varied as needed for a given application. In some examples, the coupling receptacle is larger relative to the other components than depicted in the figures. In other examples, the coupling receptacle is smaller relative to the other components than depicted in the figures. Further, the reader should understand that the coupling receptacle and the other components may all be larger or smaller than described herein while maintaining their relative proportions.

Back Plate

Back plate 122 functions to electrically couple removable module 107 with power supply 102. As shown in FIG. 5, back plate 122 is in electrical communication with power supply 102. The reader can see from the exploded view of FIG. 5 that contact member 123 of removable module 107 contacts back plate 122 when removable module 107 is inserted into coupling receptacle 113 of base module 106.

The size of the back plate may be varied as needed for a given application. In some examples, the back plate is larger relative to the other components than depicted in the figures. In other examples, the back plate is smaller relative to the other components than depicted in the figures. Further, the reader should understand that the back plate and the other components may all be larger or smaller than described herein while maintaining their relative proportions.

Tab

Tab 114 functions to cooperate with a slot 115 of removable module 107 to selectively couple removable module 107 to base module 106. As shown in FIGS. 4 and 5, tab 114 selectively inserts into slot 115 when removable module 107 is aligned properly and inserts into coupling receptacle 113. The reader can see in FIGS. 4 and 5 that tab 114 moves longitudinally into a first slot portion 116 of slot 115 when removable module 107 inserts into coupling receptacle 113. When removable module 107 is twisted after tab 114 is disposed in first slot portion 116, tab 114 moves laterally into a second slot portion 117 of slot 115.

The number of tabs in the charging system may be selected to meet the needs of a given application. The reader should appreciate that the number of tabs may be different in other examples than is shown in the figures. For instance, some charging system examples include additional or fewer tabs than described in the present example.

The shape of the tab may be adapted to be different than the specific examples shown in the figures to suit a given application. For example, the tab may include a face having the shape of a regular or irregular polygon, such as a circle, oval, triangle, square, rectangle pentagon, and the like. Additionally or alternatively, the tab may include a face having an irregular shape. In three dimensions, the shape of the tab may be a sphere, a pyramid, a cone, a cube, and variations thereof, such as a hemisphere or a frustoconical shape.

The size of the tab may be varied as needed for a given application. In some examples, the tab is larger relative to the other components than depicted in the figures. In other examples, the tab is smaller relative to the other components than depicted in the figures. Further, the reader should understand that the tab and the other components may all be larger or smaller than described herein while maintaining their relative proportions.

Source Connectors

The source connectors serve to electrically couple base module 106 to power supply 102. In the example shown in FIGS. 1-9, base module 106 includes two source connectors, first source connector 126 and second source connector 127. As depicted in FIG. 3, first source connector 126 is oriented to electrically couple to power supply 102 from rear face 124 and second source connector 127 is oriented to electrically couple to power supply 102 from lateral face 125.

The number of source connectors in the charging system may be selected to meet the needs of a given application. The reader should appreciate that the number of source connectors may be different in other examples than is shown in the figures. For instance, some charging system examples include additional or fewer source connectors than described in the present example.

The source connectors may be any currently known or later developed type of power connector. The reader will appreciate that a variety of power connector types exist and could be used in place of the source connectors shown in the figures. In addition to the types of power connectors existing currently, it is contemplated that the charging systems described herein could incorporate new types of power connectors developed in the future.

Removable Module

As shown in FIGS. 1-9, removable module 107 removably and electrically couples to base module 106. The reader can see in FIGS. 1-9 that removable module 107 removably couples to base module 106 when removable module 107 inserts into coupling receptacle 113. As depicted in FIGS. 4 and 5, removable module 107 includes a slot 115 complementarily configured with tab 114 to receive tab 114 when removable module 107 inserts into coupling receptacle 113.

In the example shown in FIGS. 1-9, removable module 107 includes a power receptacle 110, a second power receptacle 150, an electronics system 108, a contact member 123, a display 190, and a button 180. In other examples, the removable module includes fewer components, such as not including a second power receptacle, a display, or a button. The removable module may include additional or alternative components as well.

With reference to FIG. 5, removable module 107 electrically couples to base module 106 by contacting back plate 122 when inserted into coupling receptacle 113. As shown in FIG. 5, contact member 123 contacts back plate 122 when removable module 107 is inserted into coupling receptacle 113 to electrically couple removable module 107 and base module 106.

FIG. 1 depicts two removable modules, removable module 107 and second removable module 136, configured to interchangeably couple with base module 106. Removable module 107 and second removable module 136 are configured with different power receptacles and electronics systems to couple with and supply power to different devices.

As shown in FIG. 1, removable module 107 is configured to couple with first device 131 having a first power connector 132. With further reference to FIG. 1, second removable module 136 is configured to couple with second device 133 having a second power connector 134. Power receptacle 110 of removable module 107 is complementarily configured with first power connector 132. Second removable module 136 includes a second power receptacle 142 complementarily configured with second power connector 134.

Electronics system 108 of removable module 107 shown in FIG. 5 outputs a first output current at first specified power parameters compatible with the power requirements of first device 131. The electronics system of second removable module 136 outputs a second output current at second specified power parameters compatible with the power requirements of second device 133.

Removable module 107 and second removable module 136 are each complementarily configured with coupling receptacle 113 to insert into coupling receptacle 113. As depicted in FIG. 1, removable module 107 and second removable module 136 interchangeably couple to base module 106 when selectively inserted into coupling receptacle 113 and contacting back plate 122. As shown in FIGS. 1-9, removable module 107 and second removable module 136 are configured to be selectively removed from base module 106 manually without tools.

The shape of the removable module may be adapted to be different than the specific examples shown in the figures to suit a given application. For example, the removable module may include a face having the shape of a regular or irregular polygon, such as a circle, oval, triangle, square, rectangle pentagon, and the like. Additionally or alternatively, the removable module may include a face having an irregular shape. In three dimensions, the shape of the removable module may be a sphere, a pyramid, a cone, a cube, and variations thereof, such as a hemisphere or a frustoconical shape.

The size of the removable module may be varied as needed for a given application. In some examples, the removable module is larger relative to the other components than depicted in the figures. In other examples, the removable module is smaller relative to the other components than depicted in the figures. Further, the reader should understand that the removable module and the other components may all be larger or smaller than described herein while maintaining their relative proportions.

The role of slot 115 is to receive tab 114 to interlock with base module 106. The reader can see in FIGS. 4 and 5 that slot 115 includes a first slot portion 116 extending longitudinally and a second slot portion 117 extending laterally from first slot portion 116. With reference to FIGS. 4 and 5, first slot portion 116 extends longitudinally from a first end 119 disposed proximate base module 106 to a second end 120 distal base module 106. As shown in FIGS. 4 and 5, second slot portion 117 extends laterally from second end 120 of first slot portion 116.

With reference to FIGS. 4 and 5, removable module 107 selectively locks to base module 106 when removable module 107 rotates in a first twist direction 118 to move tab 114 disposed in first slot portion 116 laterally into second slot portion 117. As shown in FIGS. 4 and 5, removable module 107 selectively unlocks from base module 106 when removable module 107 rotates in a second twist direction opposite first twist direction 118 to move tab 114 laterally out of second slot portion 117. The reader can see in FIGS. 4 and 5 that removable module 107 decouples from base module 106 when tab 114 exits first slot portion 116.

The size of the slot may be varied as needed fora given application. In some examples, the slot is larger relative to the other components than depicted in the figures. In other examples, the slot is smaller relative to the other components than depicted in the figures. Further, the reader should understand that the slot and the other components may all be larger or smaller than described herein while maintaining their relative proportions.

The shape of the slot may be adapted to be different than the specific examples shown in the figures to suit a given application. For example, the slot may include a face having the shape of a regular or irregular polygon, such as a circle, oval, triangle, square, rectangle pentagon, and the like. Additionally or alternatively, the slot may include a face having an irregular shape. In three dimensions, the shape of the slot may be a sphere, a pyramid, a cone, a cube, and variations thereof, such as a hemisphere or a frustoconical shape.

Electronics System

Electronics system 108 depicted in FIG. 5 is configured to convert the supply power parameters of the supply current to an output current with the specified power parameters of power connector 132 and first device 131. The electronics system may be any currently known or later developed type of electronics system. The reader will appreciate that a variety of electronics system types exist and could be used in place of the electronics system shown in the figures. In addition to the types of electronics systems existing currently, it is contemplated that the charging systems described herein could incorporate new types of electronics systems developed in the future.

Power Receptacle

The role of power receptacle 110 is to physically and electrically couple with power connector 132. As depicted in FIG. 1, power receptacle 110 is complementarily configured with power connector 132 to receive power connector 132 inserted into power receptacle 110. When power connector 132 is inserted into power receptacle 110, power receptacle 110 delivers the output current to power connector 132.

The reader can see in FIGS. 1-9 that removable module 107 includes a second power receptacle 150. The second power receptacle is an optional feature not present in all examples. In some examples, the removable module includes more than two power receptacles.

In the example shown in FIGS. 1-9, power receptacle 110 is a USB receptacle. However, the power receptacle may be any currently known or later developed type of power receptacle. The reader will appreciate that a variety of power receptacle types exist and could be used in place of the power receptacle shown in the figures. In addition to the types of power receptacles existing currently, it is contemplated that the charging systems described herein could incorporate new types of power receptacles developed in the future.

The shape of the power receptacle may be adapted to be different than the specific examples shown in the figures to suit a given application. For example, the power receptacle may include a face having the shape of a regular or irregular polygon, such as a circle, oval, triangle, square, rectangle pentagon, and the like. Additionally or alternatively, the power receptacle may include a face having an irregular shape. In three dimensions, the shape of the power receptacle may be a sphere, a pyramid, a cone, a cube, and variations thereof, such as a hemisphere or a frustoconical shape.

The size of the power receptacle may be varied as needed for a given application. In some examples, the power receptacle is larger relative to the other components than depicted in the figures. In other examples, the power receptacle is smaller relative to the other components than depicted in the figures. Further, the reader should understand that the power receptacle and the other components may all be larger or smaller than described herein while maintaining their relative proportions.

Display

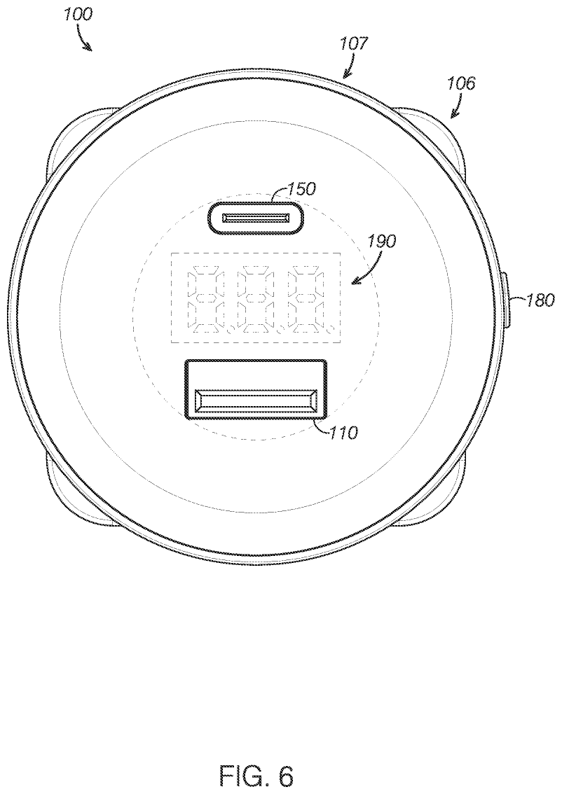

With reference to FIG. 6, the reader can see that display 190 is configured to display a series of numerals. In the present example, the series of numerals displayed correspond to information related to the power input and output of charging system 100. However, the display may display and relevant information to the user. In some examples, the charging system does not include a display.

In the example shown in FIG. 6, display 190 is a seven-segment digital display. However, the display may be any currently known or later developed type of display. The reader will appreciate that a variety of display types exist and could be used in place of the display shown in the figures. In addition to the types of displays existing currently, it is contemplated that the charging systems described herein could incorporate new types of display developed in the future.

The size and shape of the display may be varied as needed for a given application. In some examples, the display is larger relative to the other components than depicted in the figures. In other examples, the display is smaller relative to the other components than depicted in the figures. Further, the reader should understand that the display and the other components may all be larger or smaller than described herein while maintaining their relative proportions.

Button

Button 180 functions to control the brightness of display 190 and to turn display 190 on or off. In other examples, the button may be configured to additionally or alternatively control other aspects of the charging system. In some examples, the charging system does not include a button.

### Additional Embodiments

With reference to the figures not yet discussed, the discussion will now focus on additional charging system embodiments. The additional embodiments include many similar or identical features to charging system 100. Thus, for the sake of brevity, each feature of the additional embodiments below will not be redundantly explained. Rather, key distinctions between the additional embodiments and charging system 100 will be described in detail and the reader should reference the discussion above for features substantially similar between the different charging system examples.

### Charging System Embodiment Two

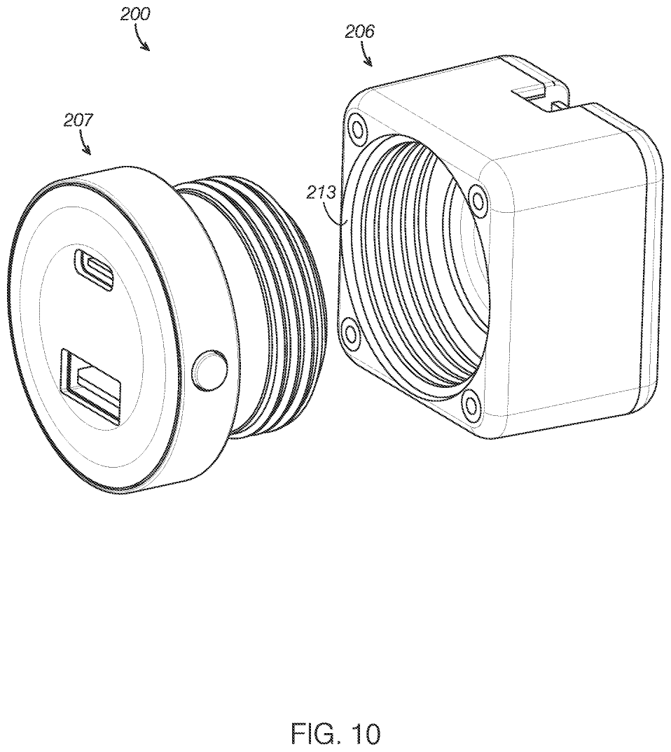

Turning attention to FIG. 10, a second example of a charging system, charging system 200, will now be described. As can be seen in FIG. 10, charging system 200 includes a base module 206 and a removable module 207.

The primary distinction between charging system 200 and charging system 100 is that base module 206 and removable module 207 are configured to threadingly couple rather than couple by inserting tab 114 of base module 106 into a slot 115 of removable module 106. Other than the threaded coupling features of charging system 200, its components are configured similarly to charging system 100.

With reference to FIG. 10, the reader can see that base module 206 defines a coupling receptacle 213. As shown in FIG. 10, coupling receptacle 213 is threaded. As depicted in FIG. 10, removable module 207 is complementarily threaded with coupling receptacle 213. As a result, removable module 207 is configured to threadingly couple with coupling receptacle 213.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A charging system for a panel with access to a power supply that supplies a supply current with supply power parameters to charge a device with a power connector configured to operate at specified power parameters, the charging system comprising:
a base module fixedly mounted to the panel and electrically coupled to the power supply;
a removable module removably and electrically coupled to the base module;
wherein the base module delivers the supply current from the power supply to the removable module;
wherein the removable module includes:
an electronics system configured to convert the supply power parameters of the supply current to an output current with the specified power parameters of the power connector;
a power receptacle complementarily configured with the power connector to electrically couple with the power connector and to deliver the output current to the power connector.

2. The charging system of claim 1, wherein:
the panel has an external side facing a user and internal side opposite the external side facing away from the user; and
the base module is mounted to the internal side of the panel.

3. The charging system of claim 1, wherein:
the base module defines a coupling receptacle complementarily configured with the removable module to receive the removable module;
the removable module removably couples to the base module when the removable module inserts into the coupling receptacle.

4. The charging system of claim 3, wherein:
the base module includes a tab disposed in the coupling receptacle;
the removable module includes a slot complementarily configured with the tab to receive the tab; and
the tab selectively inserts into the slot when the removable module inserts into the coupling receptacle.

5. The charging system of claim 4, wherein:
the slot includes a first slot portion extending longitudinally; and
the tab moves longitudinally into the first slot portion when the removable module inserts into the coupling receptacle.

6. The charging system of claim 5, wherein:
the slot includes a second slot portion extending laterally from the first slot portion;
the removable module selectively locks to the base module when the removable module rotates in a first twist direction to move the tab laterally into the second slot portion.

7. The charging system of claim 6, wherein:
the first slot portion extends longitudinally from a first end disposed proximate the base module to a second end distal the base module; and
the second slot extends laterally from the second end of the first slot portion.

8. The charging system of claim 6, wherein the removable module selectively unlocks from the base module when the removable module rotates in a second twist direction opposite the first twist direction to move the tab laterally out of the second slot portion.

9. The charging system of claim 8, wherein the removable module decouples from the base module when the tab exits the first slot portion.

10. The charging system of claim 3, wherein:
the coupling receptacle is threaded;
the removable module is complementarily threaded with the coupling receptacle to threadingly couple with the coupling receptacle.

11. The charging system of claim 3, wherein:
the base module includes a back plate disposed on the coupling receptacle distal the panel;
the back plate is in electrical communication with the power supply; and
the removable module electrically couples to the base module by contacting the back plate when inserted into the coupling receptacle.

12. The charging system of claim 11, wherein the removable module includes a contact member that contacts the back plate when inserted into the coupling receptacle to electrically couple the removable module and the base module.

13. The charging system of claim 1, wherein:
the base module includes a rear face;
the base module includes a lateral face disposed transverse to the rear face;
the base module includes a first source connector to electrically couple to the power supply;
the base module includes a second source connector to electrically couple to the power supply;
the first source connector is oriented to electrically couple to the power supply from the rear face; and
the second source connector is oriented to electrically couple to the power supply from the lateral face.

14. The charging system of claim 13, wherein the base module is configured to mount to the panel and removably couple with the removable module with the lateral face oriented in a desired direction within a 360-degree range to more conveniently couple to the power supply.

15. A charging system for an panel with access to a power supply that supplies a supply current with supply power parameters, the panel having a front side facing a user and a rear side opposite the front side, the charging system configured to interchangeably charge a first device with a first power connector configured to operate at first specified power parameters and a second device with a second power connector configured to operate at second specified power parameters, the charging system comprising:
a base module fixedly mounted to the rear side of the panel and electrically coupled to the power supply;
a first removable module configured to removably and electrically couple to the base module;
a second removable module configured to removably and electrically couple to the base module;
wherein the base module delivers the supply current from the power supply to either the first removable module or the second removable module depending on which removably module is selectively coupled to the base module;
wherein the first removable module includes:
a first electronics system configured to convert the supply power parameters of the supply current to a first output current with the first specified power parameters of the first power connector;
a first power receptacle complementarily configured with the first power connector to electrically couple with the first power connector and to deliver the first output current to the first power connector,
wherein the second removable module includes:
a second electronics system configured to convert the supply power parameters of the supply current to a second output current with the second specified power parameters of the second power connector;
a second power receptacle complementarily configured with the second power connector to electrically couple with the second power connector and to deliver the second output current to the second power connector.

16. The charging system of claim 15, wherein the first power connector is configured differently than the second power connector.

17. The charging system of claim 15, wherein the first specified power parameters are different than the second specified power parameters.

18. The charging system of claim 15, wherein:
the base module defines a coupling receptacle;
the first removable module is complementarily configured with the coupling receptacle to insert into the coupling receptacle;
the second removable module is complementarily configured with the coupling receptacle to insert into the coupling receptacle;
the first removable module and the second removable module interchangeably couple to the base module when selectively inserted into the coupling receptacle.

19. The charging system of claim 18, wherein:
the base module includes a back plate disposed on the coupling receptacle distal the panel;
the back plate is in electrical communication with the power supply; and
the first removable module and the second removable module electrically couple to the base module by contacting the back plate when inserted into the coupling receptacle.

20. The charging system of claim 15, wherein:
the first removable module is configured to be selectively removed from the base module manually without tools; and
the second removable module is configured to selectively couple with the base module manually without tools.
